(19) United States
(12) Patent Application Publication
(10) Pub. No.: US 2014/0235314 A1
(43) Pub. Date: Aug. 21, 2014

(54) POSITIONING SYSTEM FOR LOCALIZATION OF GEOGRAPHICAL ADDRESSES

(71) Applicant: Jan Stocklassa, Bromma (SE)

(72) Inventor: Jan Stocklassa, Bromma (SE)

(21) Appl. No.: 14/125,328

(22) PCT Filed: May 15, 2012
(86) PCT No.: PCT/SE2012/000074

§ 371 Date: Dec. 11, 2013

Related U.S. Application Data
(60) Provisional application No. 61/499,716, filed on Jun. 22, 2011.

(30) Foreign Application Priority Data
May 17, 2011 (SE) 1100374-6

(51) Int. Cl. G06F 17/30

(52) U.S. Cl. CPC G06F 17/30864; G06F 17/30241
USPC 463/17; 707/706

(57) ABSTRACT

The geographical positioning system and method therefor are adapted to pair at least one address of a person to a selected persons address in at least one of a predetermined distance and/or circle emanating from the geographical address of the selected person, and/or a distance/circle from where a predetermined number of persons live in proximity to the selected person.

### TECHNICAL FIELD

The present invention pertains to a geographical positioning system adapted to pair at least one of an address to a person, and addresses to a multiple of persons against a selected persons address in proximity to the geographical address for the selected person, and a method therefore.

### BACKGROUND ART

In several technical areas there exists a need to pinpoint persons living in proximity to one another in circles from a selected person living there.

For example, this could be the case in police matters pinpointing persons that have a criminal record, a system utilized to perform gaming, finding persons with the same or similar last name, and other known tasks for pinpointing positions searched.

There are lots of systems on the market utilized to geographically pinpoint persons, animals, vehicles and the like as individuals/objects, but not in numbers of individuals/objects in one search relating to one another regarding a given task. These systems utilize for instance GPS (Geographical positioning Systems), cellular phone base stations, and others.

US 2002/0059226 describes an invention where a candidates position is entered through for instance a computer, wherein other candidates in a predetermined area are related to the entered candidate.

### SUMMARY OF THE INVENTION

One aim among others of the present invention system is to pair at least one address of a person to a selected persons address in at least one of a predetermined distance and/or circle emanating from the geographical address of the selected person, and/or a distance/circle from where a predetermined number of persons live in proximity to the selected person.

Hence, it sets forth a geographical positioning system adapted to pair at least one of an address to a person, and addresses to a multiple of persons against a selected persons address in proximity to the geographical address for the selected person. Thus the present invention comprises

a computerized task control and administration site;

a display device connected to the site;

a person database connected to the site via a search engine device, which provides names and addresses to all the people, being stored for a predetermined task of the system;

the search engine by utilizing a suitable software adapted to the systems task, and the software through the site is prompted to identify and select the selected person randomly out of the person database through at least one of a person's name, address, provided code, and a provided number, which have been assigned to the selected person;

a geographical position device in a server in connection with the site, which localizes the selected person and the address, the site asking the search engine to pair a predetermined number of persons, which live in proximity of the selected person through an algorithm adapted to the task;

a questionaries' database providing relevant questions from different suitable subjects proper to the tasks of the system to a selected person to answer;

a device providing the selected person with at least one selected question from the questionnaire database, the question being selected from the different subjects suitable to the task of the system task;

whereby the question is selected out off the different subjects suitable for the task of the system; and

if the selected persons answer to the provided question is at least one of one which is relevant to the question, and correct, whereby a circle localizes at least the one mentioned person.

One embodiment of the present invention provides that it is adapted to answer to juridical/police embodiments of the tasks.

Another embodiment provides that it is adapted to raffle lottery and/or lottery/game tasks.

A further embodiment provides an algorithm adapted before a raffle at a lottery/game to secure that all valid tickets are geographically marked by localizing the selected the selected persons/players address on a map , and whereby the coordinates for the address are stored as data, which is utilized as a basis to select other persons/winners in each raffle.

Moreover, the present invention provides a geographical positioning method adapted to pair at least one of an address to a person, and addresses to a multiple of persons against a selected persons address in proximity to the geographical address for the selected person, characterized in comprising the steps of:

a computerized task control, and an administration site;

a device adapted to display at least selected persons addresses in connection with the site;

connecting a person database to the site via a search engine device, which provides names and addresses to all the people, being stored for a predetermined task of the system;

the search engine being adapted by utilizing a suitable software to the systems task, and the software through the site is prompted to identify and select the selected person randomly out from the person database through at least one of a person's name, address, provided code, and a provided number, which have been assigned to the selected person;

geographically positioning through the positioning device in a server in connection with the site localizing the selected person and the address, the site asking the search engine to pair a predetermined number of persons, which live in proximity of the selected person through an algorithm adapted to the task.

The attached independent method claims of the present invention adhere to the attached independent system claims.

### A BRIEF DESCRIPTION OF THE DRAWING

Henceforth, reference is had to the accompanying drawing throughout the present description for a better understanding of the present inventions embodiments, and given examples, wherein:

FIG. 1 schematically illustrates a geographical positioning system in accordance with the present invention.

### DETAILED DESCRIPTION OF PREFERRED EMBODIMENTS

The present invention regards a geographical positioning system. As mentioned, in several technical areas there exists a need to pinpoint persons living in proximity to one another in a distance and/or circle from a selected person living there. For example, this could be the case in police matters pinpointing persons that have a criminal record, a system utilized to perform gaming, finding persons with similar names, and other known tasks for pinpointing positions/locations searched. It is also possible in one embodiment to randomly select a person depending of the distance of living from a selected person. These persons can either receive a reward, a task to fulfill i.e. working together to resolve a task or a punishment.

An aim among others of the system is to pair at least one address of a person to a selected persons address in at least one of a predetermined distance and/or circle emanating from the geographical address of the selected person, distance and/or circle from where a predetermined number of persons live in proximity to the selected person.

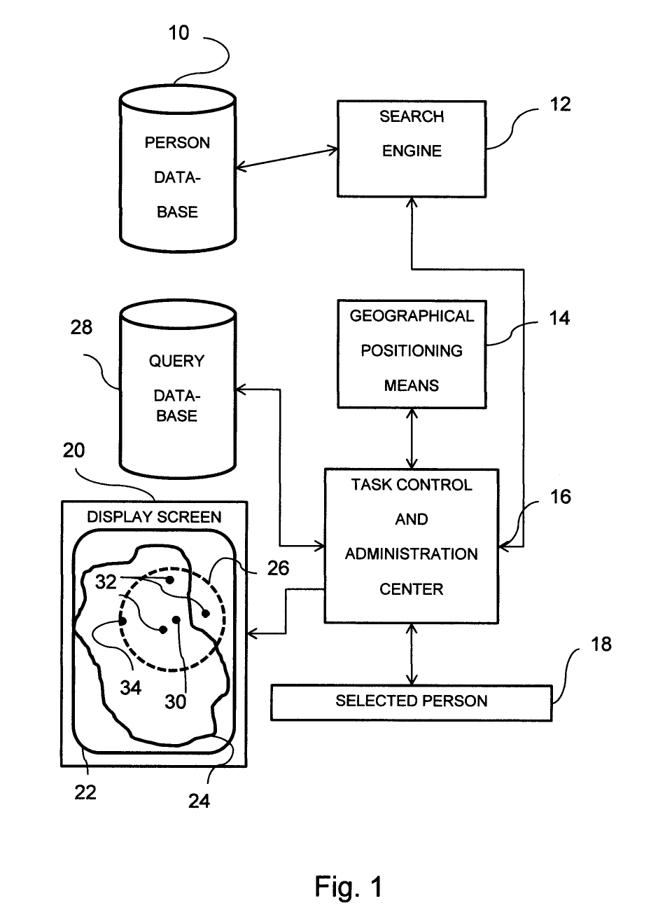

The single FIG. 1 schematically depicts one possible embodiment of a system in accordance with the present invention. Hereby, the system comprises a person database 10, connected to a search engine means capable of retrieving names addresses and/or a given code, and a provided number given to the selected person for the specific task provided by the system. Moreover, the system comprises a geographical positioning means 14, and a computerized task control and administration center 16, to which a person selected 18 by the person database 10 can be connected to via for instance a PC, laptop, cellular phone, smartphone such as Iphone ®, Ipad ®, a game console, public switched telephone network (PSTN)/cellular phone and a TV set, and like apparatuses/devices, or a person visiting a studio site where the center 16 is situated answering questions by voice, console, or keyboard. In one embodiment the display screen can be broadcasted to the mentioned apparatuses/devices or provided through a homepage.

The person database 10 could provide identities, addresses of an entire population in a country, multiple of countries, city, in a county, or the like.

Furthermore, the center 16 is connected to a display device 20 with a display screen 22, which also in one embodiment of the present invention is visible to the selected person 18 for instance through the mentioned apparatuses. Also, in one embodiment of the present invention there is a query database 28 in connection with the center 16, which provides questions to a selected person 18.

Through one task of the present invention system a police/law enforcement department could track a former criminal or criminal person selected 18 from the person database 10, and pair other persons in the database 10 to the selected person 18 for any reason suitable for the pairing of for instance a similar criminal trade, done time in the same prison, and other like police/law matters. The system could also be utilized to find persons with the same name such as nicknames, Christian and/or last names.

In order to pair a selected person 18 to other persons all residing in the database 10, the present invention utilizes a geographical positioning means 14 through preferably software that can be adapted to perform the tasks of locating persons in the database 10 through their addresses. Such adaptable software can be provided from for instance the ESRI company developing geographic information systems (GIS) utilizing their ArcGis server. Hence, the positioning means 14 can be provided by the ArcGis server.

Thus, a selected person 18 is first determined by the positioning means 14 software and through a random generator, by being delivered from the engine means 12 through center 16. An engine means 12 provides the selected person 18 from the person database by utilizing a software means/algorithm suitable for the task of the system. The center 16 prompts the software to identify the selected person 18 from the person database through at least one of a person name, address, given code, and a provided number given to the selected person. A number or a code could for instance be civic registration number/code/characters, a lottery ticket number/code, a bank account number, or other like codes/characters.

Hereby, the retrieved selected persons 18 location is delivered to the positioning system 14 pinpointing 30 the selected person 18 on a map 24, in one embodiment of the invention, displayed (herein schematically depicted) on the screen 22. This map 24 could for instance depict a neighborhood where the selected person 18 lives, city, town, country or the like, i.e. the map 24 can be of a size that matches the population density for the system task performed or the task itself.

Henceforth, the center 16 asks the engine 12 to pair a predetermined number of persons, at least one person, living closest 32, 34 to the selected person 18 by an algorithm adapted to the task. The person 34 in this example thus lives in a distance/circle 26, which is depicted on the screen 22, whereby the person 34 is included in the task of the system. The distance/circle 26 can be put on the screen 22, having a radius emanating from the selected person to the person 34 living remotest from the selected person 18, either crossing the pinpointed location or including it within the circle 26. Another possible embodiment of the present invention comprises that the distance/circle 26 is predetermined, and thus all persons 32, 34 living in or on the distance/circle 26 are chosen.

If there are more than one person living at different very adjacent addresses, one of the persons is randomly picked by a random generator. Furthermore in one embodiment all the selected persons are ranked in distance from the selected person.

Moreover, in yet one embodiment the query database 28 is utilized to provide at least one question to be answered by the selected person 18. If the question is important for the system task or correctly answered by the selected person, the distance/circle 26 is drawn/appears on the map 24 in accordance with the above mentioned manner.

In one embodiment of the system the task is a lottery. Prior to a raffle/draw of the lottery, the system ensures that all valid lottery tickets are geographically-tagged (geo-tagged) by mapping selected person/player's 18 address onto a map 24, and the coordinates of the address are recorded. This data will then be utilized as the basis for selecting other persons/winners 32, 34 in each draw by the engine means 12. The most accurate map 24 and coordinate data available will be utilized to ensure optimal fairness in a draw.

The geographic proximity to the 1^{st} prize winner address, selected person 18, will determine the other winners 32, 34. An algorithm in the engine means 12 determines the playerID residing nearest the 1^{st} prize winner address, the second nearest and so on until the correct amount of winning tickets is achieved, and the circle 26 will appear on the screen 22 map 24 through the position means 16. It is not necessary that all persons will win the same prize or amount of money. As an example, the selected person 18 wins for instance a million in a specific currency, and that the other selected persons win the amount of 100.000 in this currency. In gaming/lottery, It is also possible in one embodiment to randomly select a person depending on the distance of living from a selected person. These persons can either receive a reward, a task to fulfill i.e. working together to resolve a task or a punishment.

The attached set of claims determines other possible embodiments of the present invention to a person skilled in the art of the present technical field.

I claim:

1. A geographical positioning system adapted to pair at least one of an address to a person and addresses to a multiple of persons against a selected persons address in proximity to the geographical address for said selected person, comprising:
a computerized task control and administration site;
a display device connected to said site;
a person database connected to said site via a search engine device, which provides names and addresses to all said people, being stored for a predetermined task of said system;
said search engine by utilizing a suitable software adapted to said systems task, and said software through said site is prompted to identify and select said selected person randomly out of said person database through at least one of a person's name, address, provided code, and a provided number, which have been assigned to said selected person;
a geographical position device in a server in connection with the site, which localizes said selected person and said address, said site asking said search engine to pair a predetermined number of persons, which live in proximity of the selected person through an algorithm adapted to said task.

2. A system according to claim 1, wherein a questionaries' database provides relevant questions from different suitable subjects proper to the tasks of said system to a selected person to answer;
a device providing said selected person with at least one selected question from said questionnaire database, said question being selected from said different subjects suitable to the task of the system task;
whereby said question is selected out off said different subjects suitable for the task of the system; and
if said selected persons answer to said provided question is at least one of one which is relevant to said question, and correct, whereby a circle localizes at least said one mentioned person.

3. A system according to claim 1, wherein the system is adapted to answer to juridicial/police embodiments of said tasks.

4. A system according to claim 1, wherein the system is adapted to raffle lottery and/or lottery/game tasks.

5. A system according to claim 4, wherein an algorithm is adapted before a raffle at a lottery/game to secure that all valid tickets are geographically marked by localizing the selected the selected persons/players address on a map, and whereby said coordinates for said address are stored as data, which is utilized as a basis to select other persons/winners in each raffle.

6. A geographical positioning method adapted to pair at least one of an address to a person, and addresses to a multiple of persons against a selected (18) persons address in proximity to the geographical address for said selected person, comprising the steps of:
a computerized task control, and administration site;
a device adapted to display at least selected persons addresses in connection with said site;
connecting a person database to said site via a search engine device, which provides names and addresses to all said people, being stored for a predetermined task of said system;
said search engine being adapted by utilizing a suitable software to said systems task, and said software through said site is prompted to identify and select said selected person randomly out from said person database through at least one of a person's name, address, provided code, and a provided number, which have been assigned to said selected person;
geographically positioning through said positioning device in a server in connection with the site localizing said selected person and said address, said site asking said search engine to pair a predetermined number of persons, which live in proximity of the selected person through an algorithm adapted to said task.

7. A method according to claim 1, wherein a questionaries' database provides relevant questions from different suitable subjects proper to the tasks of said system to a selected person to answer;
a device providing said selected person with at least one selected question from said questionnaire database, said question being selected from said different subjects suitable to the task of the system task;
whereby said question is selected out off said different subjects suitable for the task of the system; and
if said selected persons answer to said provided question is at least one of one which is relevant to said question, and correct, whereby a circle localizes at least said one mentioned person.

8. A method according to claim 6, wherein the method is adapted to answer to juridical/police embodiments of said tasks.

9. A method according to claim 6, wherein the method is adapted to raffle lottery and/or lottery/game tasks.

10. A method according to claim 9, wherein an algorithm is adapted before a raffle at a lottery/game to secure that all valid tickets are geographically marked by localizing the selected the selected persons/players address on a map, and whereby said coordinates for said address are stored as data, which is utilized as a basis to select other persons winners in each raffle.
